(19) United States
(12) Patent Application Publication
(10) Pub. No.: US 2012/0076576 A1
(43) Pub. Date: Mar. 29, 2012

(54) RETAINING RING

(75) Inventors: Randy L. Melanson, Pinckney, MI (US); Randal William Arndt, White Lake, MI (US)

(73) Assignee: GM GLOBAL TECHNOLOGY OPERATIONS, INC., Detroit, MI (US)

(21) Appl. No.: 12/889,487

(22) Filed: Sep. 24, 2010

(51) Int. Cl. F16B 1/02

(52) U.S. Cl. 403/319

(57) ABSTRACT

A retaining ring is characterized by a variable effective inner diameter and a variable effective outer diameter to axially retain a first member with respect to a second member.

### TECHNICAL FIELD

This invention relates to retaining rings for axially retaining a first member with respect to a second member.

### BACKGROUND

Retaining rings are employed to retain one member with respect to another member in an axial direction. For example, in transmissions having clutches and planetary gearsets arranged coaxially along a shaft, retaining rings may be set in grooves formed in the shaft to limit axial movement of the clutch elements and planetary gear members. Retaining rings include internal and external snap rings. Typically, retaining rings are installed at the end of the part chain. In some instances, due to functional or packaging requirements, it is not possible to place the ring at the end of the part chain. In such situations, a “trapped” snap ring may be employed in a ring groove located in the center of the component being retained.

### SUMMARY

A retaining ring for axially retaining a first member with respect to a second member is provided. The first member has an outer surface characterized by a first portion and a second portion spaced axially from the first portion. The first portion has a first diameter, and the second portion has a second diameter greater than the first diameter. The second member has an inner surface characterized by a third portion and a fourth portion axially spaced from the third portion. The third portion has a third diameter, and the fourth portion has a fourth diameter greater than the third diameter. The retaining ring comprises a member having a generally annular shape and characterized by an inner surface and an outer surface. The inner surface is characterized by an inner surface minor diameter that is less than or equal to the first diameter, and the outer surface is characterized by an outer surface major diameter that is greater than or equal to the fourth diameter.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, sectional, side view of a portion of a transmission including a retaining ring axially retaining a first member and a second member;

FIG. 2 is schematic, sectional, side view of portions of the first member, the second member, and the retaining ring;

FIG. 3 is a schematic, perspective view of the retaining ring;

FIG. 4 is a schematic, perspective view of the first and second members;

FIG. 5 is a schematic, sectional, perspective view of a portion of the first member, the second member, and the ring; and

FIG. 6 is a schematic, sectional, front view of a portion of the first member, the second member, and the ring.

### DETAILED DESCRIPTION

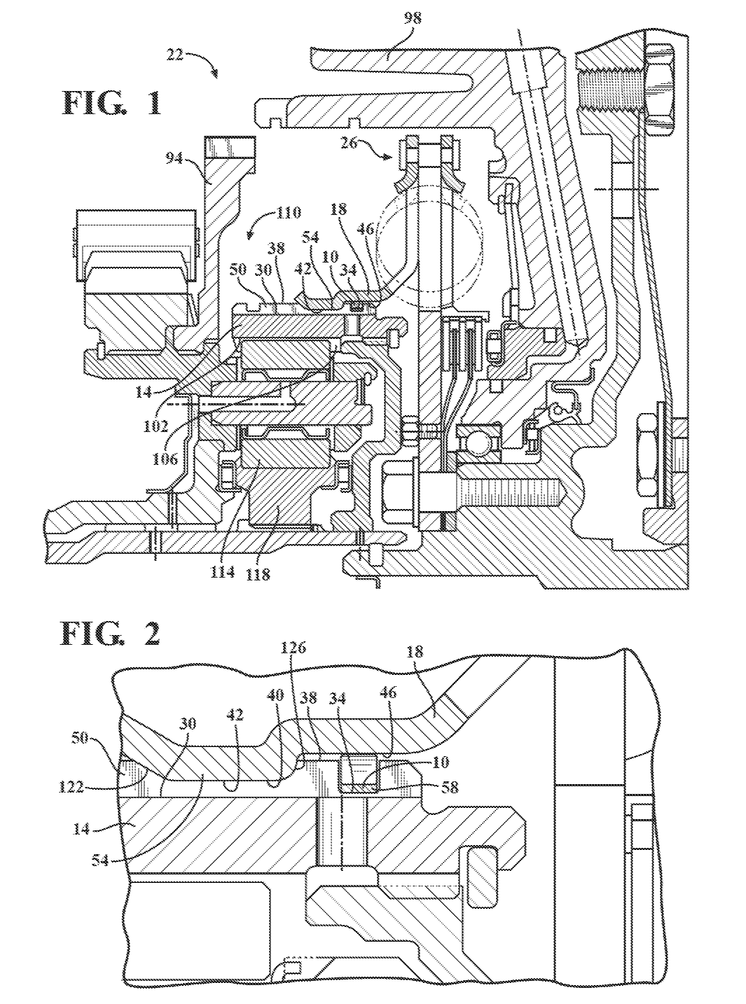

Referring to FIGS. 1 and 2, a retaining ring 10 for axially retaining a first member 14 with respect to a second member 18 is schematically depicted. In the embodiment depicted, the first member 14 is a ring gear member inside a vehicle transmission 22, and the second member 18 is the output hub of a damper bypass clutch 26. Referring to FIGS. 1, 2, and 4, the first member 14 has a generally cylindrical outer surface 30 characterized by a first portion 34 and a second portion 38. The second member 18 has a generally cylindrical inner surface 40 characterized by a third portion 42 and a fourth portion 46.

The first portion 34 is characterized by a first diameter, and the second portion 38, which is axially spaced from the first portion 34, is characterized by a second diameter that is greater than the first diameter. In the embodiment depicted, the second portion 38 defines a first plurality of splines 50 that extend radially outward from outer surface 30, and which provide the second portion 38 with a greater diameter than the first portion 34. The splines 50 are evenly spaced around the circumference of the first member 14. The first portion 34 is a groove that extends through each of the splines 50 around the circumference of the first member 14.

The third portion 42 is characterized by a third diameter, and the fourth portion 46, which is axially spaced from the third portion 42, has a fourth diameter greater than the third diameter. In the embodiment depicted, the third portion defines a second plurality of splines 54 that extend radially inward from the inner surface 40, and which provide the third portion 42 with a diameter less than the diameter of the fourth portion 46. When the first member 14 and the second member 18 are installed within the transmission, the first plurality of splines 50 are meshingly engaged with the second plurality of splines 54 to prevent rotation of the first member 14 with respect to the second member about axis A, i.e., to transmit torque from the second member 18 to the first member 14. That is, each of splines 50 is disposed between a respective two splines 54. The fourth portion 46 is also axially aligned with the first portion 34. The retaining ring 10 is disposed between the fourth portion 46 and the first portion 34.

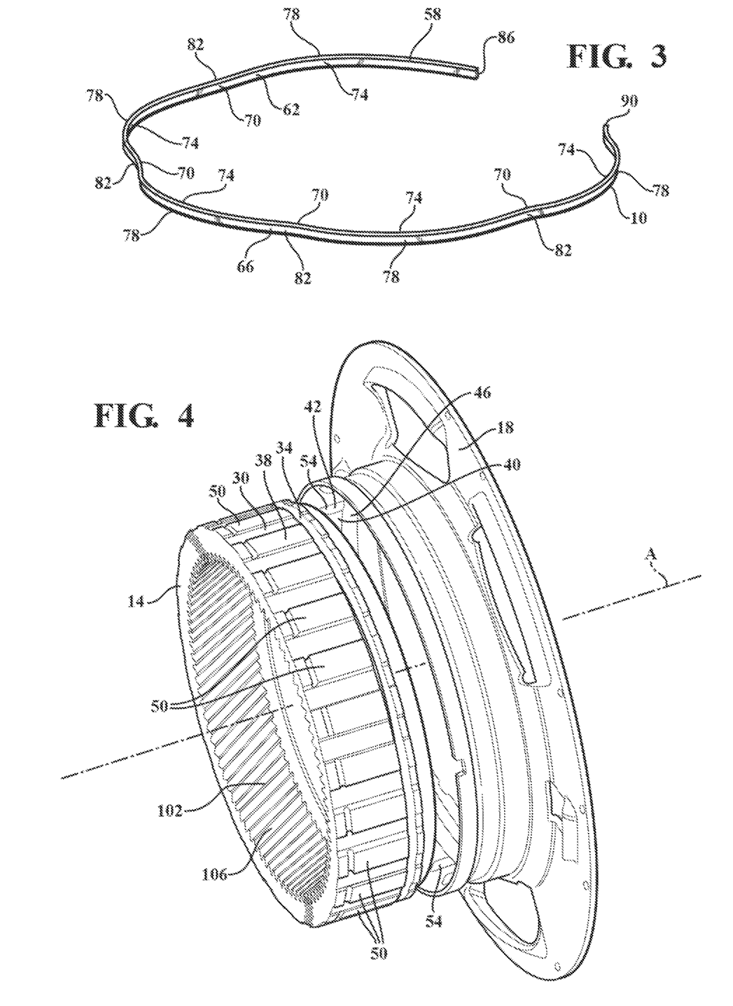

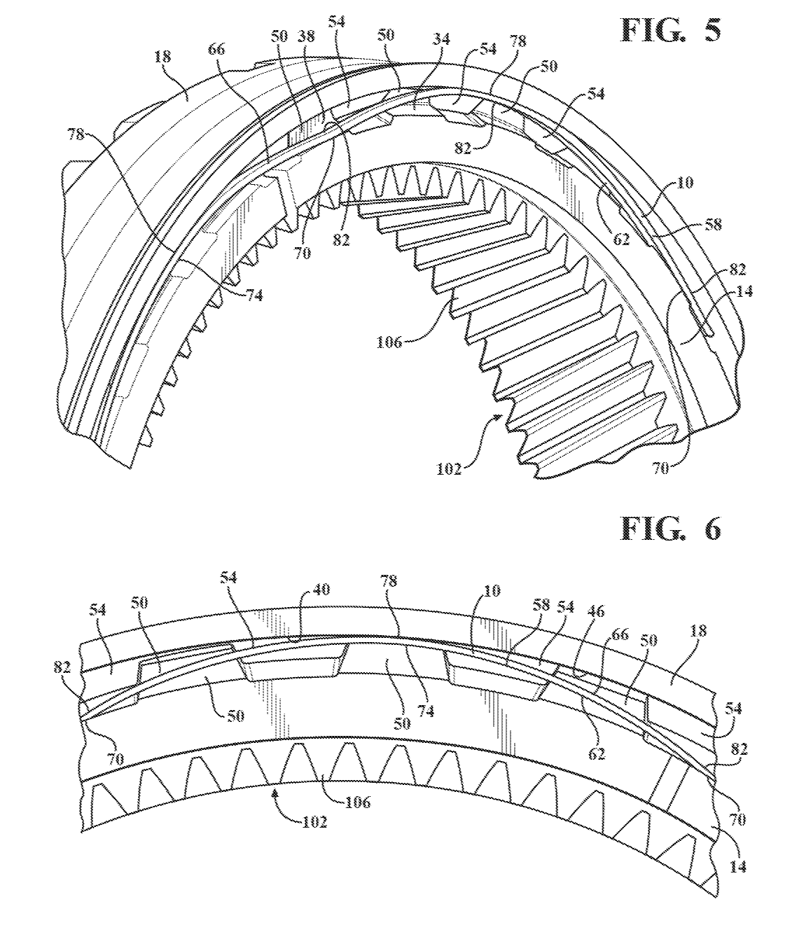

Referring to FIGS. 3, 5, and 6, the ring 10 comprises a member 58 having a generally annular shape. The member 58 is characterized by an inner surface 62 and an outer surface 66. The inner surface 62 is characterized by a plurality of alternating crests, or peaks 70, and valleys 74, such that the inner surface 62 is characterized by alternating segments that are concave and convex. Concave segments of surface 62 extend between peaks 70, and convex segments of surface 62 extend between valleys 74. The inner surface 62 is characterized by an inner surface minor diameter and an inner surface major diameter. As used herein, the inner surface minor diameter is the diameter of an imaginary cylinder that bounds or just touches the peaks 70, and the inner surface major diameter is the diameter of an imaginary cylinder that bounds or just touches the valleys 74. The inner surface minor diameter is less than or equal to the first diameter, i.e. the diameter of the first portion 34. Accordingly, as shown in FIGS. 5 and 6, the inner surface peaks 70 contact the first portion 34 of the outer surface 30 of the first member 14.

The outer surface 66 is characterized by a plurality of alternating crests, or peaks 78, and valleys 82, such that the outer surface 66 is characterized by alternating segments that are concave and convex. Concave segments of surface 66 extend between peaks 78, and convex segments of surface 66 extend between valleys 82. The outer surface 66 is characterized by an outer surface minor diameter and an outer surface major diameter. As used herein, the outer surface minor diameter is the diameter of an imaginary cylinder that bounds or just touches the valleys 82, and the outer surface major diameter is the diameter of an imaginary cylinder that bounds or just touches the peaks 78. The outer surface major diameter is less than or equal to the fourth diameter, i.e. the diameter of the fourth portion 46. Accordingly, as shown in FIGS. 5 and 6, the outer surface peaks 78 contact the fourth portion 46.

The cross-sectional shape and dimensions of member 58 is substantially constant along the length of the member 58, and thus peaks 70 in the inner surface 62 are directly radially opposite valleys 82 in the outer surface 66. Similarly, valleys 74 in the inner surface 62 are directly radially opposite peaks 78 in the outer surface 66. As best seen in FIG. 2, the axial dimension of member 58 is substantially greater than the radial dimension of member 58.

Referring specifically to FIG. 3, the member 58 includes a first end 86 and a second end 90. The first and second ends 86, 90 are circumferentially spaced apart from one another.

Referring again to FIG. 1, in the embodiment depicted, the transmission 22 includes a main housing 94 and a front housing 98. During assembly of the transmission 14, the damper bypass clutch 26 is mounted with respect to the front housing 98. The first member 14, which is a ring gear member, includes an inner surface 102 defining a plurality of teeth 106. The first member 14 is part of a planetary gearset 110, which includes a plurality of planet gears 114 and a sun gear member 118. The retaining ring 10 facilitates the assembly of the first member 14 to the second member 18 prior to mating the front housing 98 to the main housing 94 and, correspondingly, to engaging the teeth 106 of the first member with the planet gears 114.

More specifically, and with reference to FIG. 2, the splines 54 are characterized by a surface 122 that is inclined in the axial direction. As the first member 14 is inserted into the second member 18, the surface 122 contacts the ring 10 inside the groove 34 and compresses the ring 10, i.e., the surface 122 and the remainder of the splines 54 compress the ring 10 radially inward at the outer surface peaks 78. When the first member 14 has been sufficiently moved and the ring 10 is between the first portion 34 and the fourth portion 46, the ring 10 rebounds radially outward, as shown in the Figures, to axially retain the first member 14 with respect to the second member 18.

Surface 126 of splines 54, opposite surface 122, acts on the ring 10 to retain the ring, and therefore the first member 14, axially with respect to the second member 18. Surface 126 is axially inclined like surface 122, but at a steeper angle. Accordingly, removal of the first member 14 from the second member requires a larger force than installation. The installation force is determined by the angle of surface 122 and the radial stiffness of the ring 10. The removal force is determined by the angle of surface 126 and the stiffness of the ring 10. Accordingly, installation and removal forces can be varied by varying the angles of surfaces 122, 126, the material of the ring 10, the cross-sectional shape of the ring 10, etc.

The member 58 in the embodiment depicted is characterized by alternating segments that are generally arc-shaped to provide the ring 10 with the variable effective diameter; however, other segment shapes may be employed within the scope of the claimed invention. The member 58 in the embodiment depicted is characterized by a rectangular cross-section; however, other cross-sectional shapes may be employed within the scope of the claimed invention, such as square, circular, oval, etc. The retaining ring 10 and first and second members 14, 18 are shown in the context of a vehicle transmission 22; however, the retaining ring 10 and first and second members 14, 18 may be employed in any system, device, etc. within the scope of the claimed invention.

The retaining ring 10 retains the axial packaging advantages of a conventional trapped ring design while improving radial packaging and minimizing assembly issues by utilizing the characteristics of both a snap ring and flat spring. The ring 10 will not sag in the groove 34, eliminating the need to align the ring 10 prior to installing the second member 18, thereby improving assembly. Also, the groove 34 depth needs only to be deep enough to accommodate the thin section of the ring 10 during assembly. Depending upon design requirements, the angle of the rear face of the second member may be altered to facilitate disassembly over thrust load retention or vise versa.

The ring 10 may be characterized by very low radial compression loads, resulting in low installation force. The ring 10 does not require special tools either to assemble or disassemble. Adequate retention loads maintained by a combination of axial stiffness (cross section) and angle of axial mating reaction surfaces. Disassembly forces are reasonable and not excessive, requiring no special tools to disengage. The ring 10 resists centrifugal loading that can cause radial dislocation from retention groove 34, due to radial constraints at the inner diameter and the outer diameter. The ring 10 is less prone to “bellevilling” due to its inherent axial rigidity (“bellevilling” is a term used to describe the tendency of conventional snap rings to go from a flat to conical shape when under high axial loads). The ring 10 does not require deep radial grooves for adequate retention and axial support, thereby enabling reduced radial cross sections (and thereby mass, inertia, and cost) of the mating components being retained.

While the best modes for carrying out the invention have been described in detail, those familiar with the art to which this invention relates will recognize various alternative designs and embodiments for practicing the invention within the scope of the appended claims.

1. A retaining ring for axially retaining a first member with respect to a second member, the first member having an outer surface characterized by a first portion having a first diameter and a second portion axially spaced from the first portion and having a second diameter greater than the first diameter, the second member having an inner surface characterized by a third portion having a third diameter and a fourth portion axially spaced from the third portion and having a fourth diameter greater than the third diameter, the retaining ring comprising:
a member having a generally annular shape and characterized by an inner surface and an outer surface;
wherein the inner surface is characterized by an inner surface minor diameter that is less than or equal to the first diameter; and
wherein the outer surface is characterized by an outer surface major diameter that is greater than or equal to the fourth diameter.

2. The retaining ring of claim 1, wherein the inner surface is characterized by alternating concave portions and convex portions.

3. The retaining ring of claim 1, wherein the outer surface is characterized by alternating concave portions and convex portions.

4. The retaining ring of claim 1, wherein the member is characterized by an axial dimension and a radial dimension; and
wherein the axial dimension is greater than the radial dimension.

5. The retaining ring of claim 1, wherein the member includes a first end and a second end; wherein the first end is circumferentially spaced from the second end.

6. An apparatus comprising:
a first member having a generally cylindrical outer surface characterized by a first portion having a first diameter and a second portion axially spaced from the first portion and having a second diameter greater than the first diameter;
a second member having a generally cyldindrical inner surface characterized by a third portion having a third diameter and a fourth portion axially spaced from the third portion and having a fourth diameter greater than the third diameter;
a retaining ring having an inner surface and an outer surface;
said inner surface being characterized by a plurality of inner surface peaks and inner surface valleys;
said outer surface being characterized by a plurality of outer surface peaks and outer surface valleys; and
wherein the retaining ring is disposed between the first portion of the first member and the fourth portion of the second member.

7. The apparatus of claim 6, wherein the inner surface peaks contact the first portion of the first member.

8. The apparatus of claim 7, wherein the outer surface peaks contact the fourth portion of the second member.

9. The apparatus of claim 6, wherein the retaining ring comprises a member that is characterized by an axial dimension and a radial dimension; and
wherein the axial dimension is greater than the radial dimension.

10. The apparatus of claim 6, wherein the member includes a first end and a second end; and
wherein the first end is circumferentially spaced from the second end.

11. The apparatus of claim 6, wherein the first portion is a groove and the second portion defines a first plurality of splines.

12. The apparatus of claim 11, wherein the third portion defines a second plurality of splines.

13. The apparatus of claim 12, wherein the first member is a ring gear member and wherein the second member is a hub.
